(19) United States
(12) Patent Application Publication
(10) Pub. No.: US 2008/0098664 A1
(43) Pub. Date: May 1, 2008

(54) Home furnishing enhancement system

(76) Inventors: Jean T. McGregor, Waxhaw, NC (US); John F. Roberts, Charlotte, NC (US)

Correspondence Address: Giaccherini, Post Office Box 1146, Carmel Valley, CA, 93924, US

(21) Appl. No.: 11/880,469

(22) Filed: Jul. 18, 2007

Related U.S. Application Data
(60) Provisional application No. 60/835,220, filed on Aug. 1, 2006.

(51) Int. Cl. G09F 7/18; A47G 1/16

(52) U.S. Cl. 52/38; 16/402; 248/475.1; 248/231.91; 248/488

(57) ABSTRACT

Methods and apparatus for providing consumer-installed decorations (10) for home or office furnishings (F). One embodiment of the invention may be sold at a retail store. The consumer may purchase a set of one or more decorations or enhancing components (10), which comprise an ornamental component (12) and a mounting component (14). The consumer then installs the decorations (10) at home or in the office, without special tools and without requiring the services of a contractor. The decorations (10) may be installed on any generally planar structure or furnishing (F). Examples of these furnishings (F) include, but are not limited to, a mirror (M), a door (D), a picture frame (PF), a kitchen cabinet door (KC), a cubicle wall or divider (CW), a computer monitor, a table top or any other piece of furniture, fixture, appliance, hardware or item that may be found in a home or office.

### CROSS-REFERENCE TO A RELATED PENDING PATENT APPLICATION & CLAIMS FOR PRIORITY

This Non-Provisional Patent Application is related to a Pending U.S. Provisional Patent Application U.S. Ser. No. 60/835,220, filed on 1 Aug. 2006. In accordance with Sections 119 & 120 of Title 35 of the United States Code of Laws, the Applicants hereby claim the benefit of priority for any and all subject matter which is commonly disclosed in the Pending Provisional Patent Application, and in the Present Non-Provisional Patent Application.

### FIELD OF THE INVENTION

The present invention pertains to methods and apparatus for consumer-installed enhancements for home or office furnishings. More particularly, one preferred embodiment of the invention utilizes one or more components that may be mounted on a mirror, window frame, picture frame, door, cubicle wall or some other home or office structure. In one embodiment, the invention provides an enhancement for any generally planar structure, and comprises a set of components which are attached, connected or mounted to the structure by the consumer.

### BACKGROUND OF THE INVENTION

On average, American households expend approximately $4,000 annually for home improvement projects. Many of these improvements require hiring a contractor. Having workers in the home or office can be expensive, inconvenient and time-consuming. Many consumers are happy to purchase products which they can install themselves without using special tools, and without hiring a contractor. The development of such a product would satisfy long felt needs in the home and office furnishings business, and would constitute an advance in the hardware and construction industries.

### SUMMARY OF THE INVENTION

The present invention comprises methods and apparatus for providing enhancements for home or office furnishings. These enhancements generally comprise decorations, trims or embellishments; and are generally mounted, attached or otherwise installed on a home or office furnishing. This furnishing is typically a generally planar structure, such as a mirror, a door, a picture frame, a cubicle wall or kitchen cabinet doors. In one embodiment, the invention comprises an ornamental component and a mounting component. The mounting component is affixed to or deployed on the generally planar structure, and holds or carries the ornamental component.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 provides a view of one embodiment of the present invention installed on a rectangular mirror.

FIG. 2 provides a view of one embodiment of the present invention installed on an oval mirror.

FIG. 3 offers a more detailed view of one of the parts of one embodiment of the present invention, which is mounted on a corner of a mirror.

FIG. 4 offers a detailed view of one of the parts of one embodiment of the present invention, which is mounted on the side of a mirror.

FIG. 5 is a side view of one part of one embodiment of the present invention and a generally planar structure. In FIG. 5, the mounting component is a pair of hook and loop adhesive strips or two facing sections of adhesive tape.

FIG. 6 is a side view of one part of one embodiment of the present invention and a generally planar structure. In FIG. 6, the mounting component is a hanger which fits over a generally planar structure.

FIG. 7 is a side view of one part of one embodiment of the present invention and a generally planar structure. In FIG. 7, the mounting component is an adjustable bracket which fits over a generally planar structure.

FIG. 8 is a side view of one part of one embodiment of the present invention and a generally planar structure. In FIG. 8, the mounting component is a compression cap.

FIG. 9 furnishes a side view of another embodiment of the invention, which utilizes a bolt and an anchor to mount the present invention over a mirror and drywall.

FIG. 10 is a front view of the mirror shown in FIG. 9.

FIG. 11 is a front view of a mirror in combination with the present invention, which has been mounted over the mirror.

FIG. 12 depicts one part of one embodiment of the present invention installed on a door.

FIG. 13 depicts one part of one embodiment of the present invention installed on a picture frame.

FIG. 14 depicts one part of one embodiment of the present invention installed on a cubicle wall.

FIG. 15 depicts one part of one embodiment of the present invention installed on a pair of kitchen cabinet doors.

FIG. 16 offers a view of an alternative embodiment of the invention which is installed on a mirror with mounting holes.

FIG. 17 provides a view of an alternative embodiment of the invention which uses a spacer that mounts on the edge of a mirror.

FIG. 18 reveals an alternative embodiment of the invention which employs a decorative strip that includes pegs for mounting in holes through a mirror.

FIG. 19 supplies a view of decorative strips which are installed on a new mirror.

FIG. 20 illustrates the mounting method for the embodiment portrayed in FIG. 19.

FIG. 21 exhibits decorative strips that have been placed on a pre-installed mirror.

FIG. 22 is a view of an embodiment that is applied to a mirror using snap-on tabs.

FIG. 23 portrays a bracket that is employed to attach various embodiments of the invention to drywall.

FIG. 24 shows various combinations of filigree embodiments.

FIGS. 25 and 26 reveal spring clips and tabs that may be used to install the embodiments shown in FIG. 24.

FIG. 27 depicts a button embodiment of the invention, while FIG. 28 displays a mounting bracket for the button embodiment shown in FIG. 27.

FIG. 29 is a view of an embodiment that is mounted around the perimeter of a mirror.

FIGS. 30 and 31 reveal an embodiment which attaches to a mirror using clips or thin double-sided tape.

FIGS. 32, 33, 34 and 35 offer views of alternative mounting methods for the embodiment shown in FIGS. 30 and 31.

FIGS. 36, 37, 38 and 39 depicts an embodiment comprising buttons, corners and strips.

FIG. 40 supplies a view of a “four pack” mounting kit.

FIG. 41 supplies a view of a mixed set of embodiments installed on a mirror.

FIG. 42 provides a view of an alternative mounting kit.

### A DETAILED DESCRIPTION OF PREFERRED & ALTERNATIVE EMBODIMENTS

### I. Overview of the Invention

The present invention comprises methods and apparatus for providing consumer-installed decorations 10 for home or office furnishings. One embodiment of the invention may be sold at a retail store. The consumer may purchase a set of one or more decorations or enhancing components 10, which comprise an ornamental component 12 and a mounting component 14. The consumer then installs the decorations 10 at home or in the office, without special tools and without requiring the services of a contractor.

The decorations 10 may be installed on any generally planar structure or furnishing F. Examples of these furnishings F include, but are not limited to: a mirror, a door, a picture frame, a kitchen cabinet door, a window, a wall, a ceiling, a shower door, a stair riser or railing, a mantle, a lamp shade, a shelf, a light switch cover or plate, a cubicle wall or divider, a computer monitor, a table top or any other piece of furniture, fixture, appliance, hardware or item that may be found in a home or office. The invention may also be used in combination with outdoor furnishings, such as, but not limited to: a deck, a fence, an exterior wall, a shutter, a mailbox, a chimney, a gutter or a planter. The invention may also be used in combination with personal items, such as, but not limited to, a purse, a scrapbook, a backpack or a box.

In one embodiment, the decorations 10 are fabricated from a lightweight material, such as plastic. Other variations may be manufactured from: wood, paper, paperboard, metal, foil, stretched fabric, wire, ceramic tile, tape, leather, glass, rope, mirror, a natural material such as stone, woven grass, contained liquid or some other suitable material that may be fashioned as a ornamental element.

The decorations 10 are generally installed by attaching, coupling, hanging, adhering or otherwise affixing a mounting component 14 to a furnishing F. The various embodiments of the mounting component 14 include, but are not limited to: hangers, hooks, straps, rods or mechanical fasteners; adjustable straps; hook-and-loop material (such as Velcro®), single or double adhesive tapes, glues, caulks, or epoxies; compression fittings, clips or sleeves; magnetic devices; bonding waxes or gums; tension fit devices (such as a shower rod); plastic cling devices which rely upon surface tension; suction cups; elastic straps; nails or staples; cams or dowels; snaps or retaining clips; buckles or buttons; chains; tied devices (such as string or ribbon); or a threaded connector, such as bolts, screws, nuts, retainers and/or anchors.

The invention may be sold as an individual item, or in matched sets. They may be marketed and promoted as free inserts in popular magazines. They may also be colored or imprinted to depict various scenery or images, or may bear a photograph or other visual rendering or pattern. The invention may also be offered as a thematic or seasonal product, bearing designs or images for Christmas, Halloween, New Year's Day, Independence Day, birthdays, anniversaries or other holidays or memorable occasions.

In an alternative embodiment, the consumer may also purchase a kit containing software and self-adhesive, pre-cut papers which may be used to compose overlays that may be produced on a home or office computer and printer, and then placed over the decoration 10.

In another embodiment, the decoration 10 may also include additional components for: hanging key rings; a clock; a pocket for holding a cellular telephone; a candle holder; a tray for coins or sunglasses; a shelf for pencils or pens; a set of pegs for holding jewelry; a notepad holder; bins or holders for soap, a toothbrush or thermometer; hanging or supporting a cup; or holding mail or office supplies. In yet another embodiment, electronic components may be incorporated into the present invention. These electronic components may include, but are not limited to: lights; devices for producing sounds or music; a radio; light or motion activated moving parts; or a device that sprays air freshener or cologne.

The decoration 10 may be sold in the form of a kit comprising pieces of unfinished wood; paint; wire and beads; oven-bakable clay; or plaster molding supplies. Each of these components of a kit would enable the consumer to create their own designs. The invention may also be sold with special fasteners to enable the decorations 10 to be used on cabinet door pulls and door knobs.

### II. Specific Embodiments of the Invention

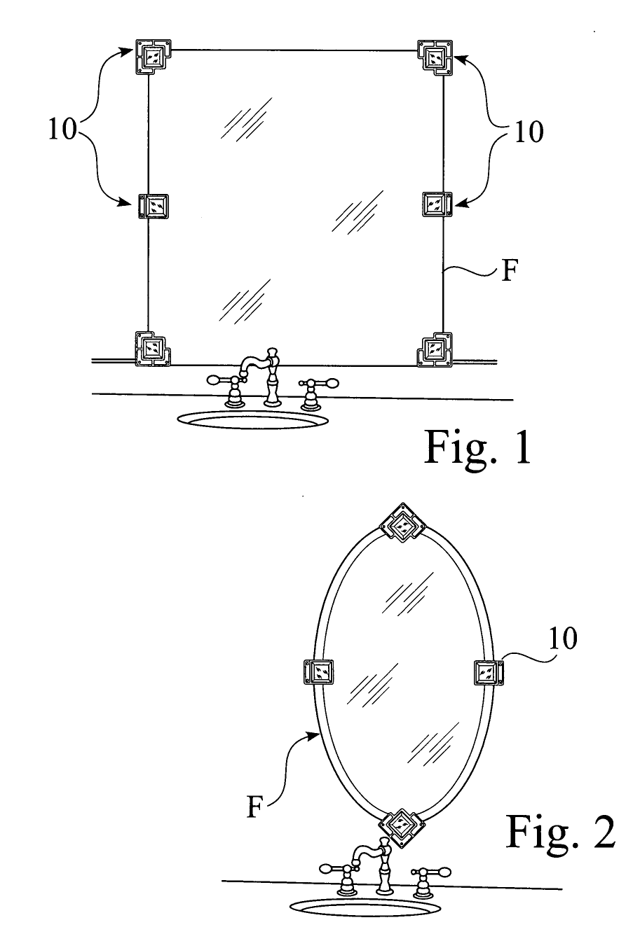

FIG. 1 offers a view of one embodiment of the present invention, called “Mirror Jewelry™,” that has been installed along the vertical edges and on the corners of the front of a bathroom mirror 15. The Trade Mark “Mirror Jewelry” is owned by the Assignee of the Present Patent Application. This set of six decorations 10 have been mounted at the corners and at the center of the vertical edges of the mirror 15. One embodiment of the invention may be installed or mounted along the edge, corner, perimeter or periphery of a planar structure, or of a structure that includes a generally flat face, region, segment or surface.

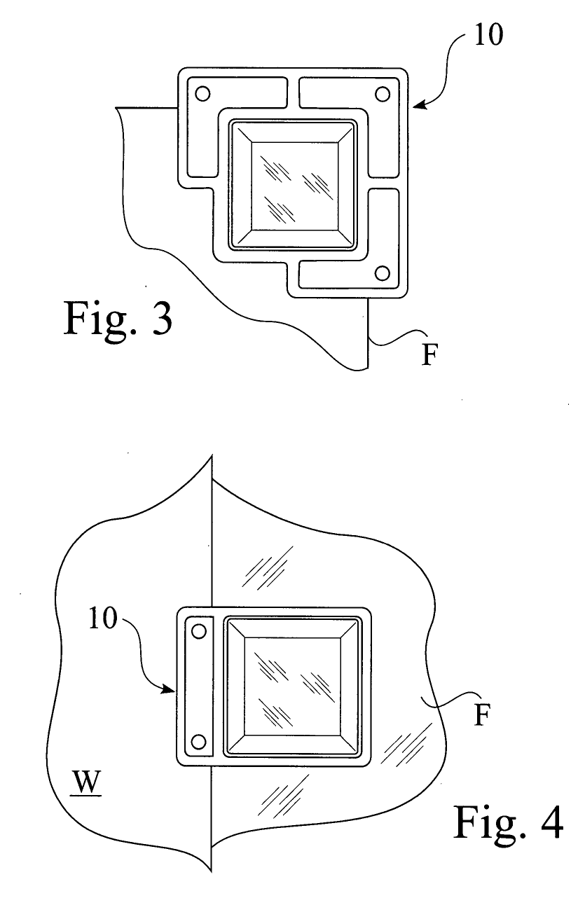

FIG. 2 is a view of one embodiment of the present invention installed on an oval mirror 15. FIGS. 3 and 4 are more detailed views of one of the parts of one embodiment of the present invention, which have been mounted on a corner and on one side of a mirror 15.

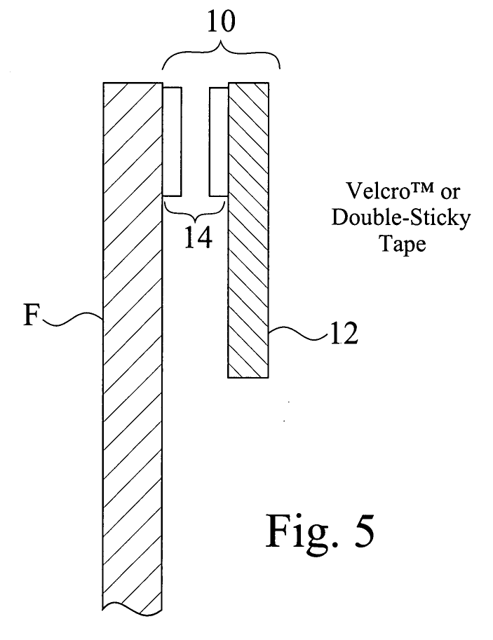

FIG. 5 is a side view of one part of one embodiment of the present invention 10 and a generally planar structure or furnishing F. An ornamental component 10 comprises a generally flat or planar member. The rear portion of the ornamental component 10, which is opposite the front face which is viewed, is attached to one piece of an attachment pad 14, such as a hook-and-loop adhesive strip or a segment of adhesive tape. Another hook-and-loop adhesive strip or segment of adhesive tape 14 is deployed on the furnishing F in a position which will hold the ornamental component 10 in its desired location.

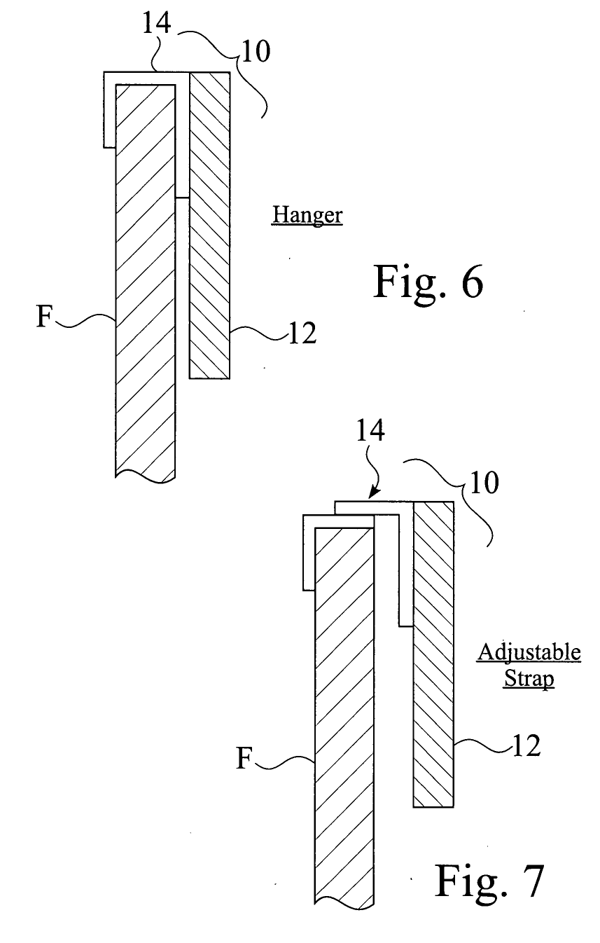

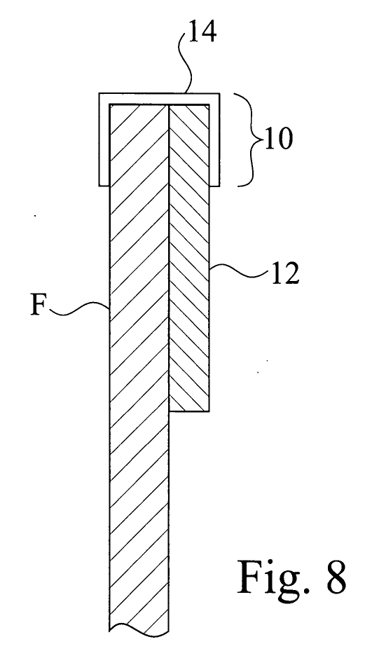

FIG. 6 depicts one part of one embodiment of the present invention in a side view. The mounting component 14 shown in FIG. 6 is a hanger which fits over a generally planar structure or furnishing F. FIG. 7 also depicts a side view of one part of one embodiment of the present invention and a generally planar structure. In FIG. 7, the mounting component 14 is an adjustable bracket which fits over a generally planar structure or furnishing F. In FIG. 8, the mounting component 14 is a compression cap that fits over both the ornamental component 12 and the furnishing F.

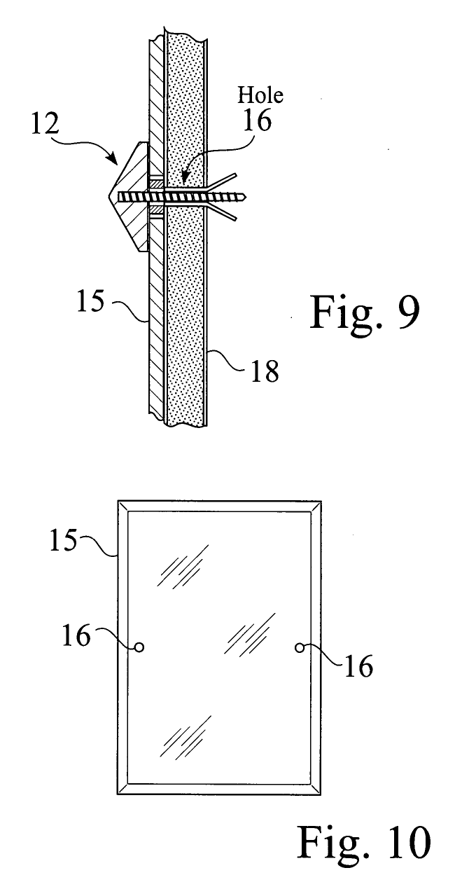

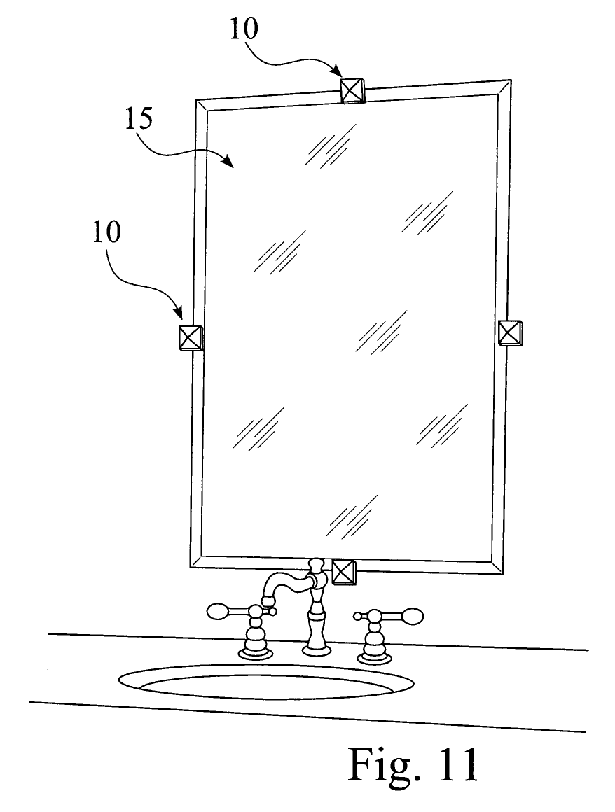

FIG. 9 exhibits another embodiment of the invention, which utilizes a bolt and an anchor fitting in a hole 16 to mount the present invention over a mirror 15 and drywall 18. FIG. 10 supplies a front view of the mirror shown in FIG. 9. FIG. 11 is a front view of the mirror shown in FIG. 9 together with the present invention, which has been mounted over the mirror 15.

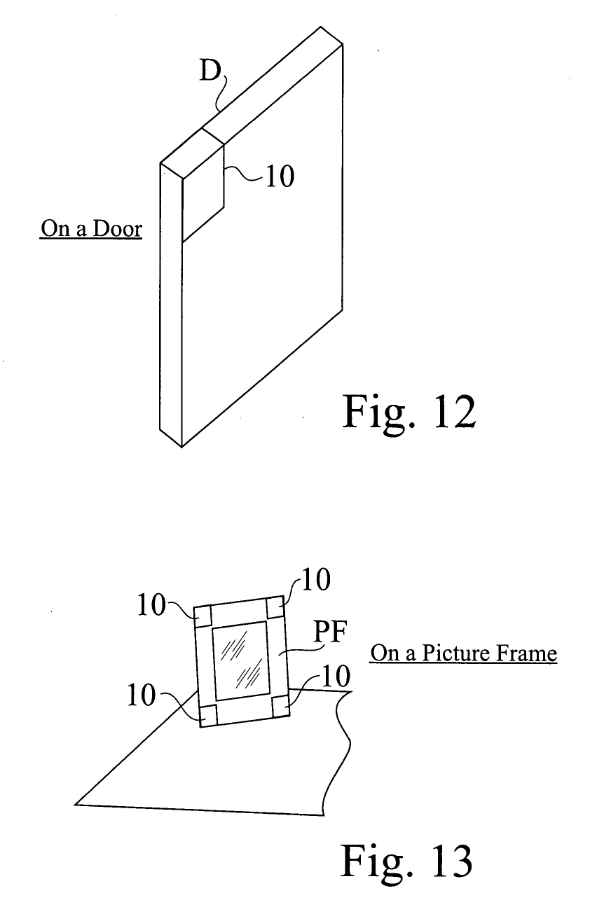

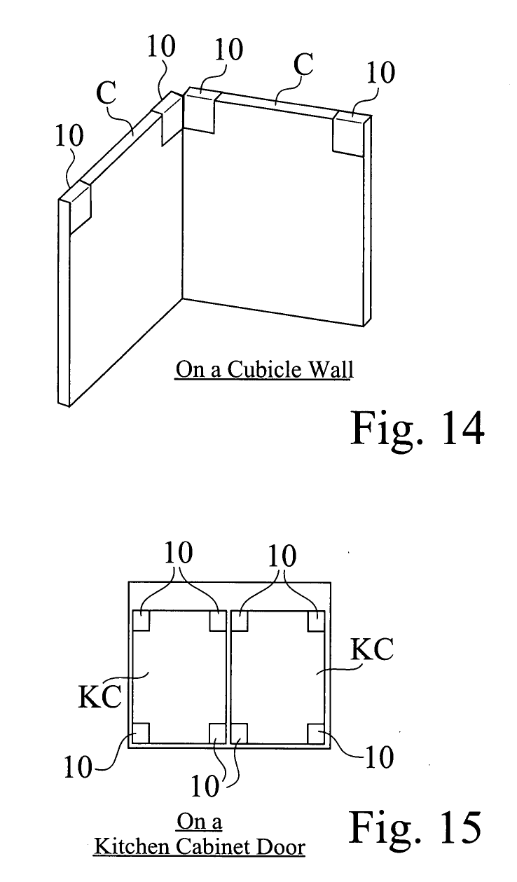

FIG. 12 depicts one part of one embodiment of the present invention installed on a door D. FIG. 13 depicts one part of one embodiment of the present invention installed on a picture frame PF. FIG. 14 depicts one part of one embodiment of the present invention installed on a cubicle wall CW. FIG. 15 depicts one part of one embodiment of the present invention installed on a pair of kitchen cabinet doors KC.

### III. Alternative Embodiments of the Invention

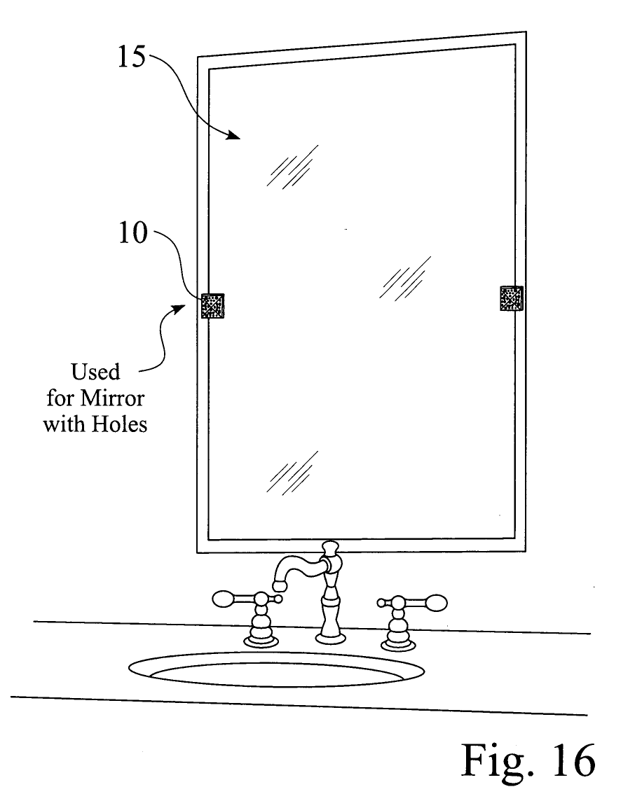

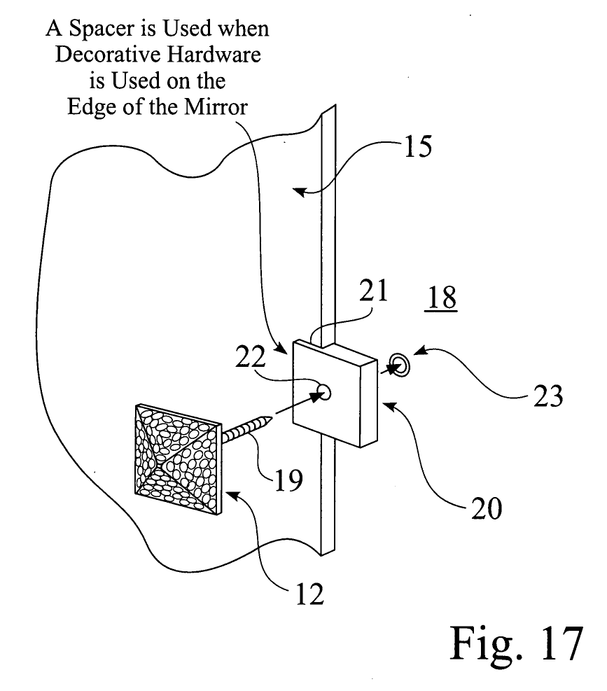

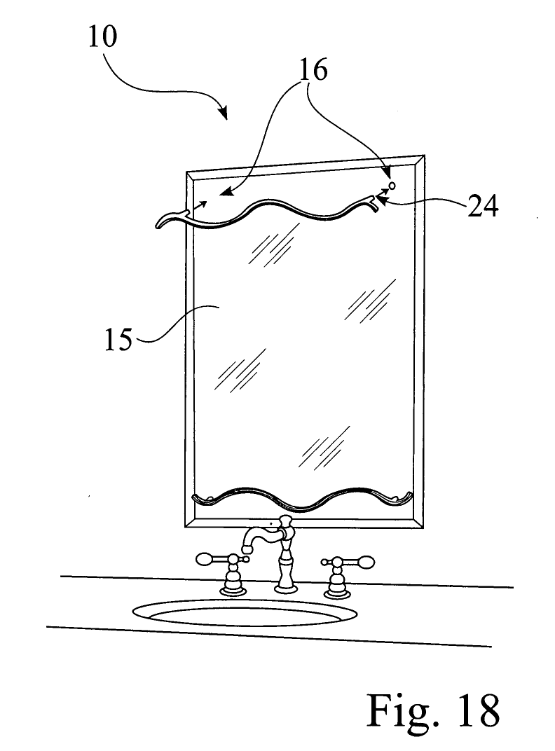

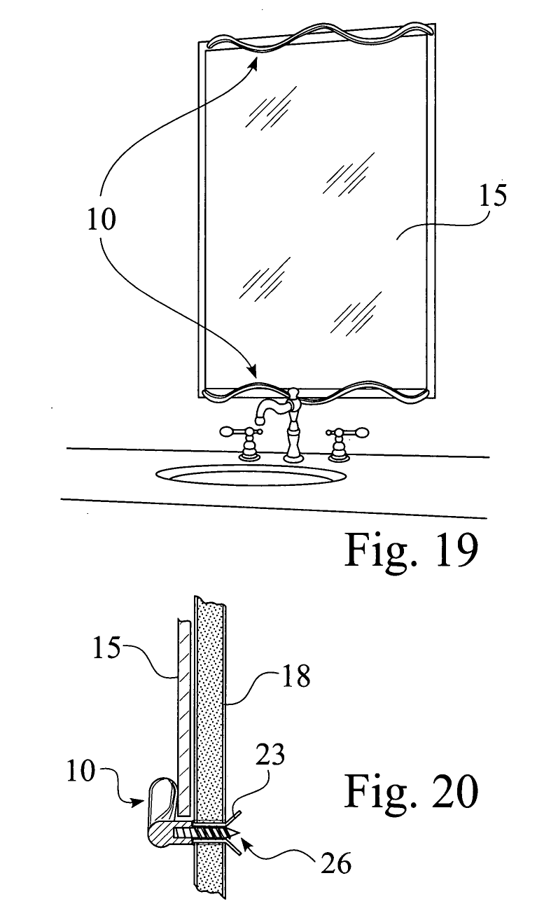

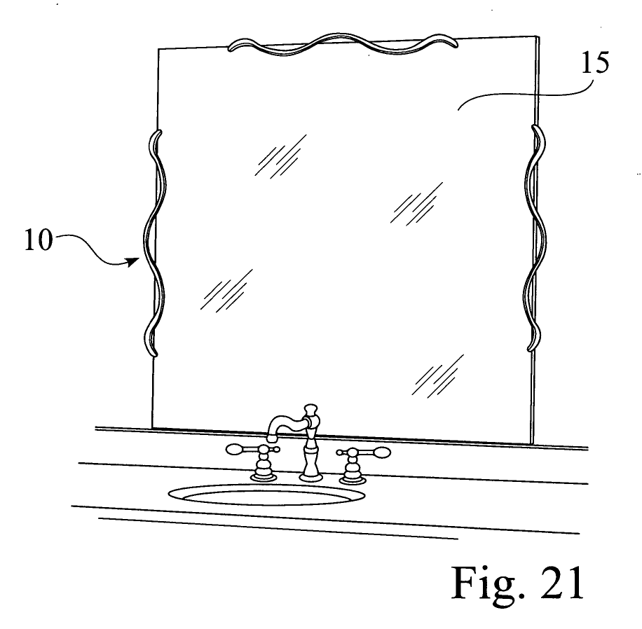

FIG. 16 offers a view of an alternative embodiment 10 that may be installed on the front of a mirror 15 that includes mounting holes. This embodiment 10 is depicted in greater detail in an exploded view in FIG. 17, which shows an ornamental component 12 is attached to its own screw 19 which fits into a spacer 20. This generally rectangular spacer 20, which is fabricated from a plastic or other suitable material, has a notched end 21 that receives, engages and holds one edge of the mirror 15. The spacer 20 has a corresponding hole 22 for the screw 19, which is ultimately received by and secured in all wall anchor 23 that has been installed in the drywall 18. FIGS. 18, 19, 20 and 21 portray another embodiment of the invention, which includes an elongated decorative strip, bar, band, ribbon, rod, wire or border 12 that is formed with one or more integral mounting pegs 24. These pegs 24 protrude from the back of the strip 12, and are designed to be inserted in holes 16 that are formed in a mirror 15, as shown in FIG. 18. FIGS. 19 and 20 depict an alternative version 12 for a mirror 15 that does not have pre-formed holes 16. As shown in FIG. 20, the decorative wire component 12 is mounted over the front surface of the mirror 15, and is held in place by a screw 26 that protrudes from the wire component 12. This screw 26 fits in a wall anchor 23 in the drywall 18. FIG. 21 reveals yet another version of decorative strips 12 that have been installed on a pre-existing mirror.

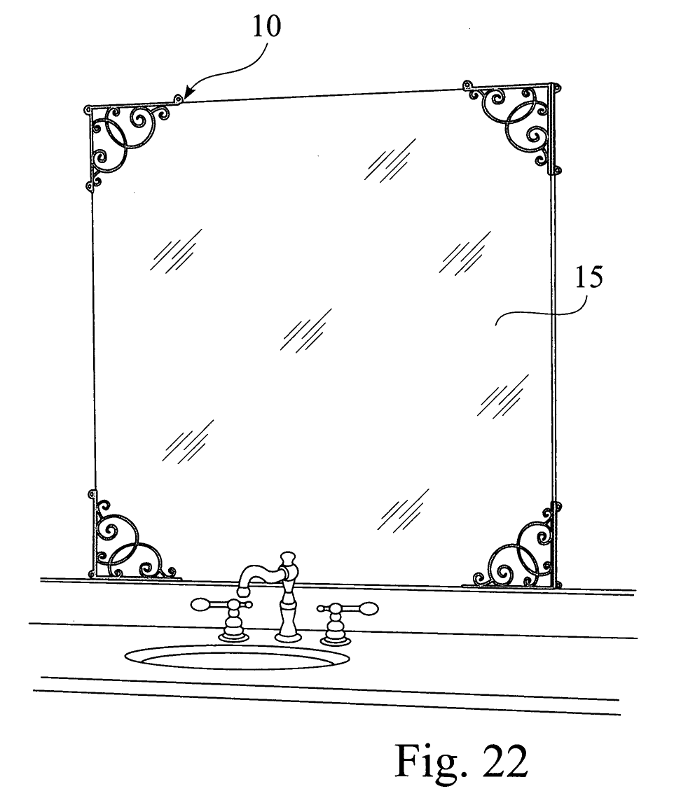

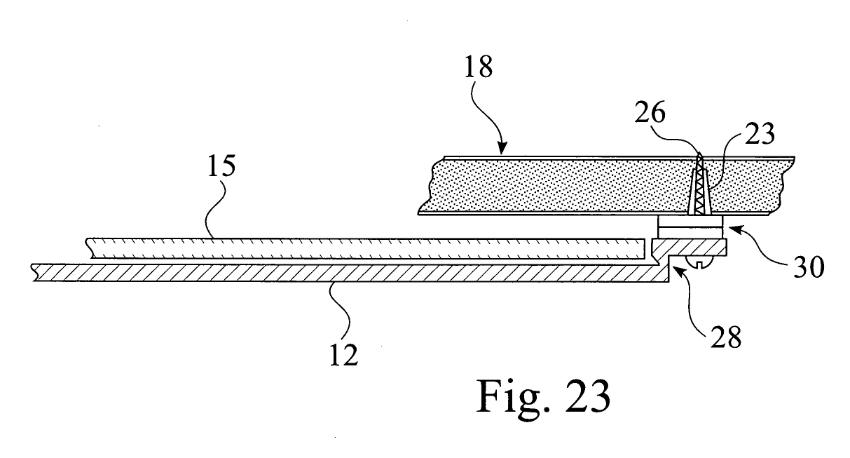

FIG. 22 provides a view of yet another variation of the invention which is placed on or over the corners of a mirror. This scroll-like embodiment includes a portion or segment that resembles a filigree, lattice, lace or some other open design. The ornamental portion 12 of this embodiment includes a “snap-off” segment 28. A screw 26 is inserted through a stack 30 of spacers, and is ultimately received by an anchor 23 in the drywall 18.

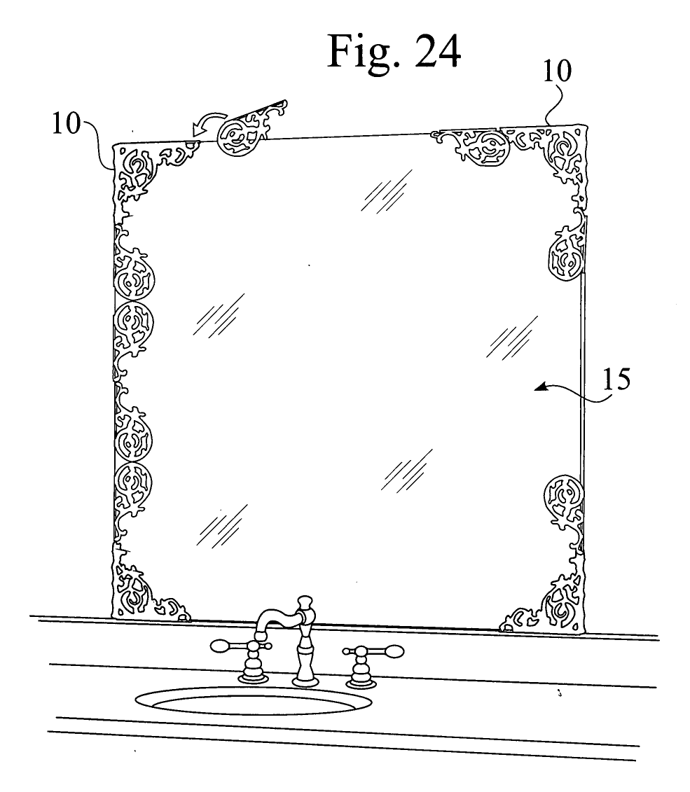

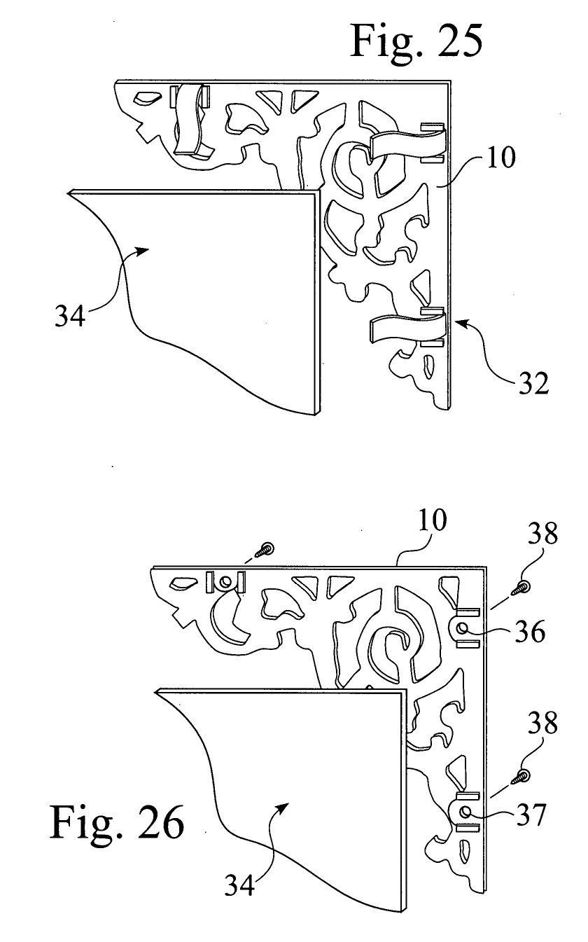

FIGS. 24, 25 and 26 exhibit another version of the invention, which comprises another filigree decoration 10 that is fitted over the front surface 15 of a mirror. This embodiment includes corner pieces and side pieces, which may be placed over any or all of the perimeter of the mirror using various combinations of corner and side pieces. FIGS. 25 and 26 present views of methods of mounting this embodiment on a mirror. FIG. 25 shows a filigree decoration 10 adapted with spring clips 32 which fit over the rear surface 34 of the mirror. FIG. 26 shows the same decoration 10 configured with tabs 36 having holes 37 that are fitted with drywall screws 38. This embodiment may also be mounted with double-sided tape.

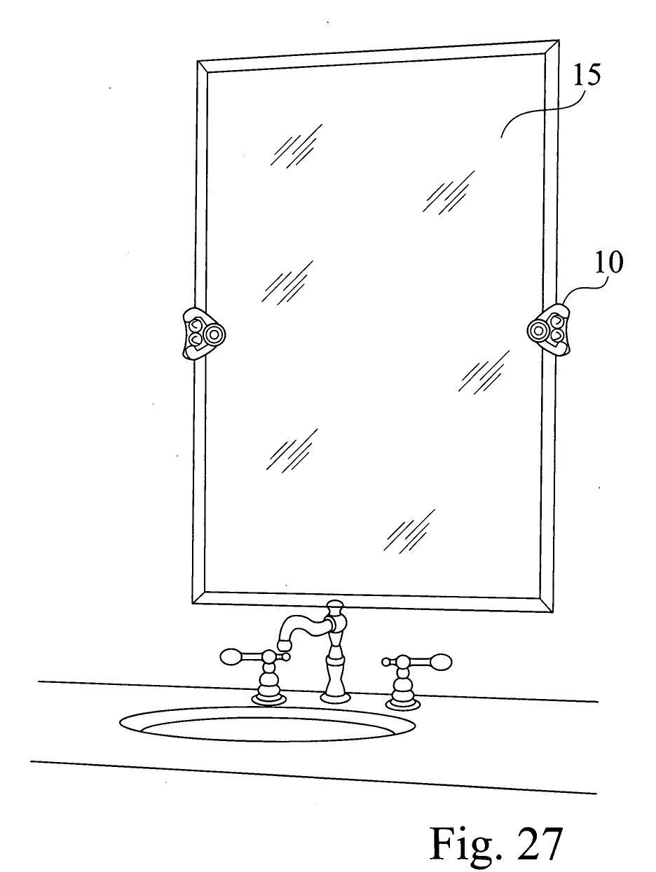

FIG. 27 presents a view of another embodiment of the invention comprising an ornamental portion 12 which is held by a screw 39 that also holds a bracket 40. This bracket 40 also includes holes 42 for screws 44 that attach the bracket 40 to anchors 23 in the drywall 18 as shown in FIG. 28.

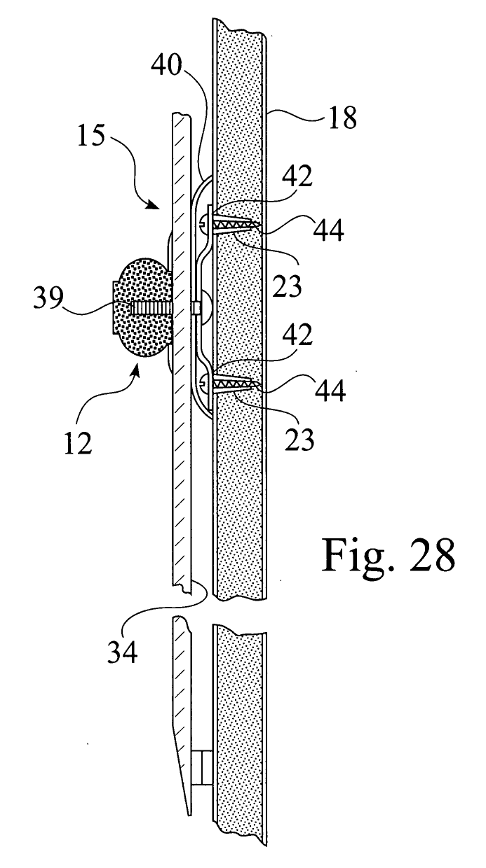

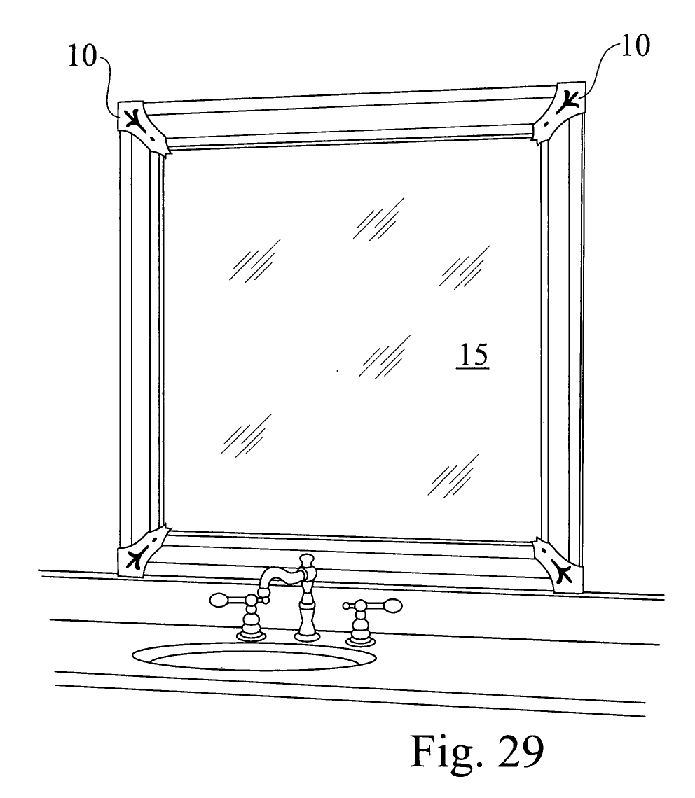

FIG. 29 furnishes a view of another variation of the invention, which is mounted around some or all of the perimeter of a mirror.

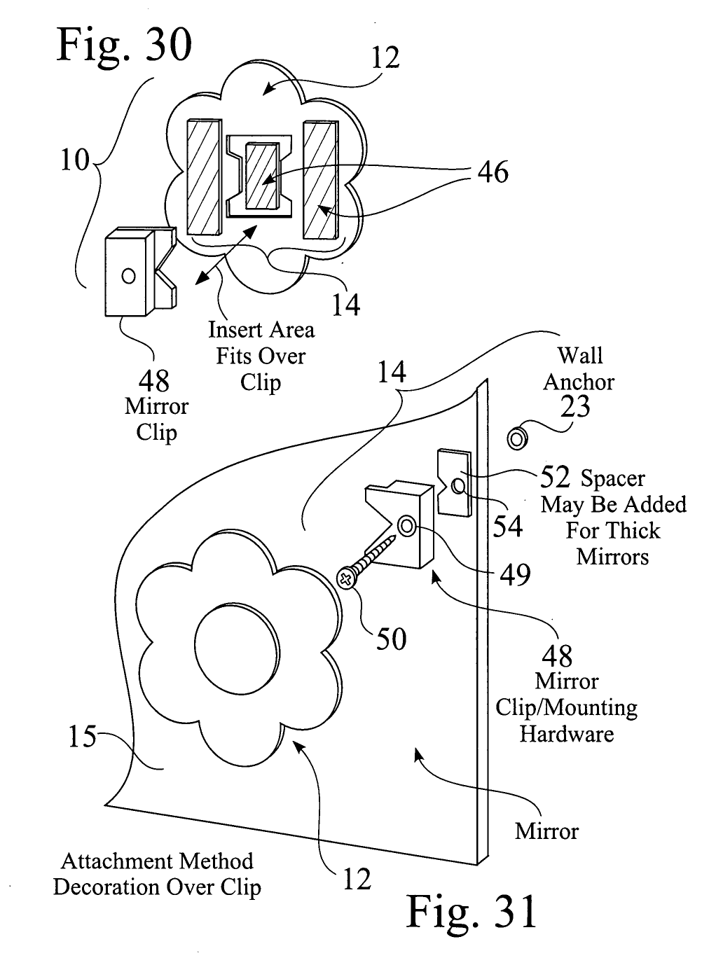

FIG. 30 portrays an embodiment of the invention which utilizes double-sided tape 46 and/or a mirror clip 48.

FIG. 31 shows how a screw 50 is inserted into a hole 49 in the mirror clip 48. A spacer 52 may be added behind the mirror clip 48 for thick mirrors. A hole 54 in the spacer 52 also receives the screw 50, which is ultimately held by a wall anchor 23 in the drywall 18.

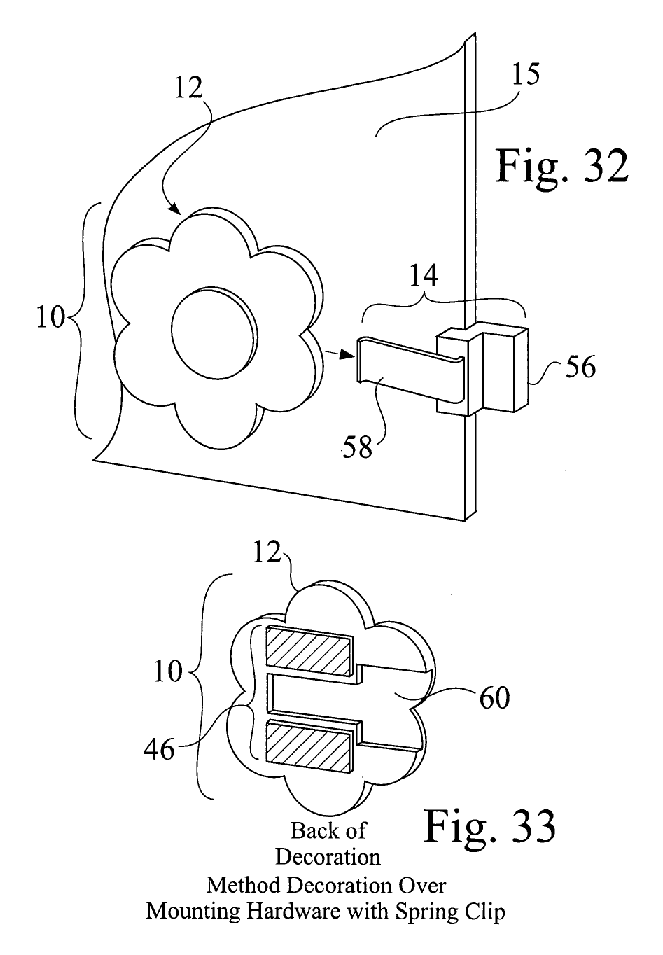

In another variation, FIG. 32 reveals mounting hardware 14 that includes a mirror mount 56 with a spring clip 58. FIG. 33 shows how the spring clip 58 slides or fits into a recess 60 on the rear side of the decorative component 12. The decorative component 12 may also be mounted using double-sided tape 46.

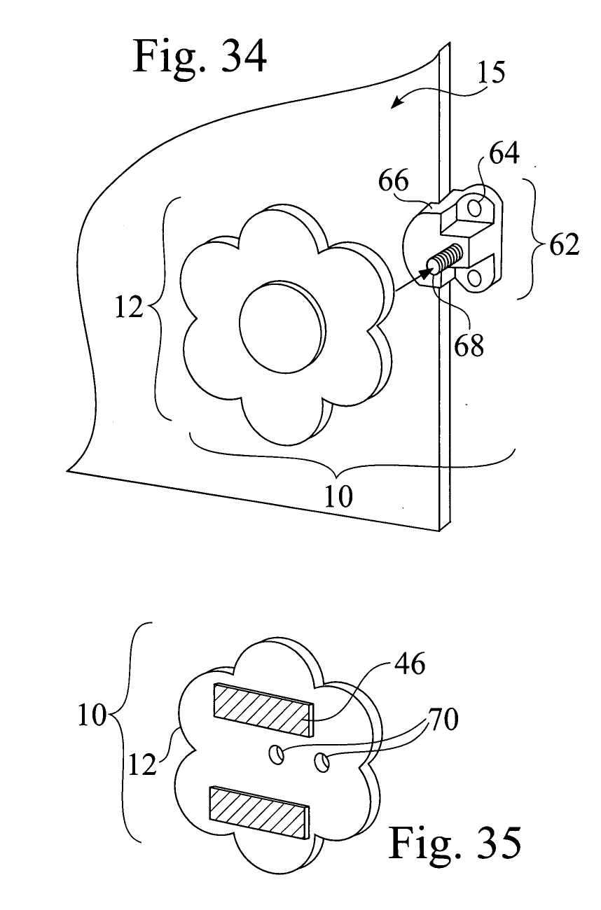

FIGS. 34 and 35 illustrate yet another alternative mounting method. An alternative mirror mount 62 is configured with mounting holes 64, a notch 66 to receive the mirror, and a threaded rod 68 or press-fit pin (not shown) which engages threaded holes formed in the decorative component 12. Double-sided tape 46 may also be employed.

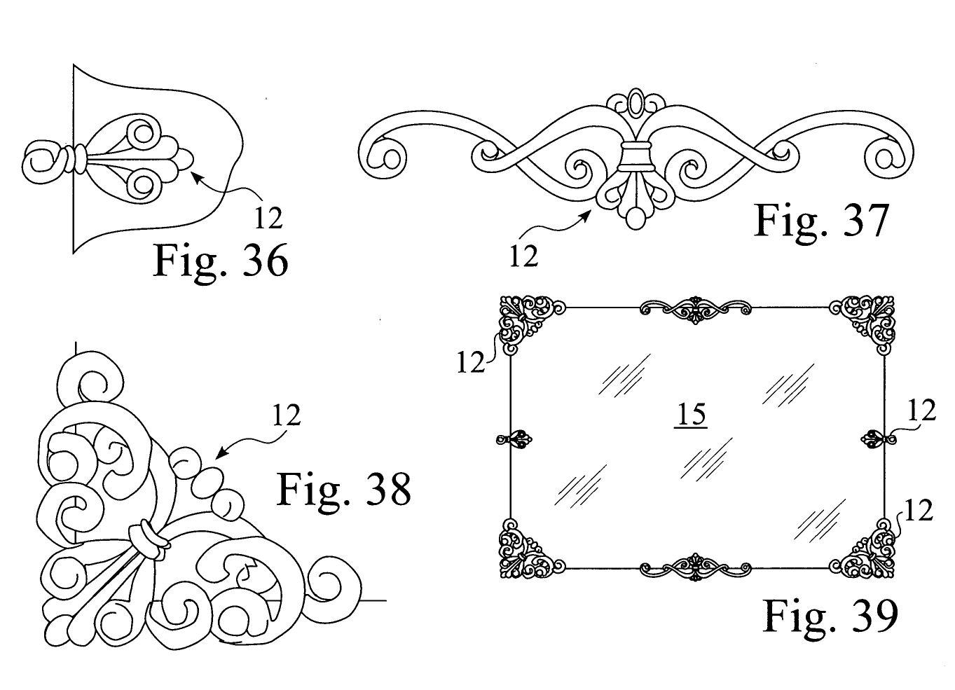

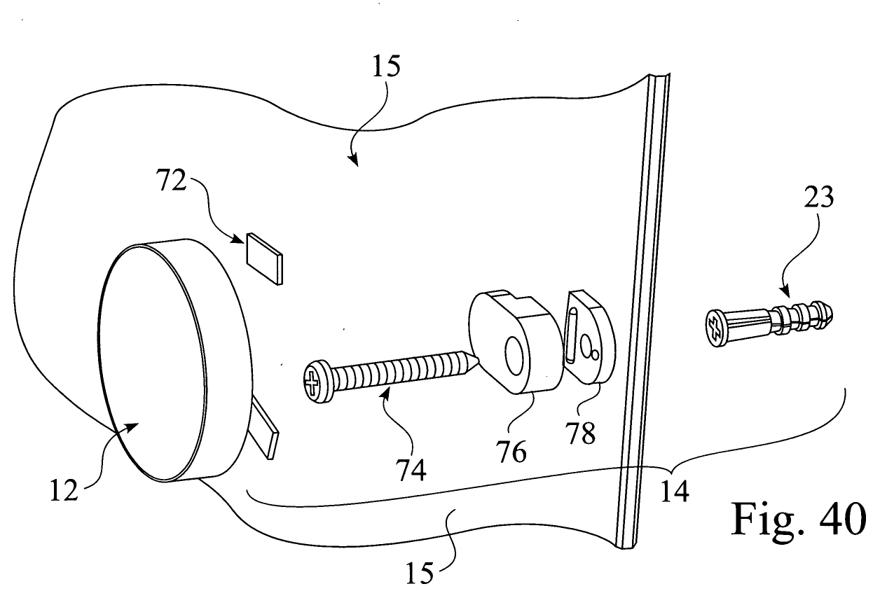

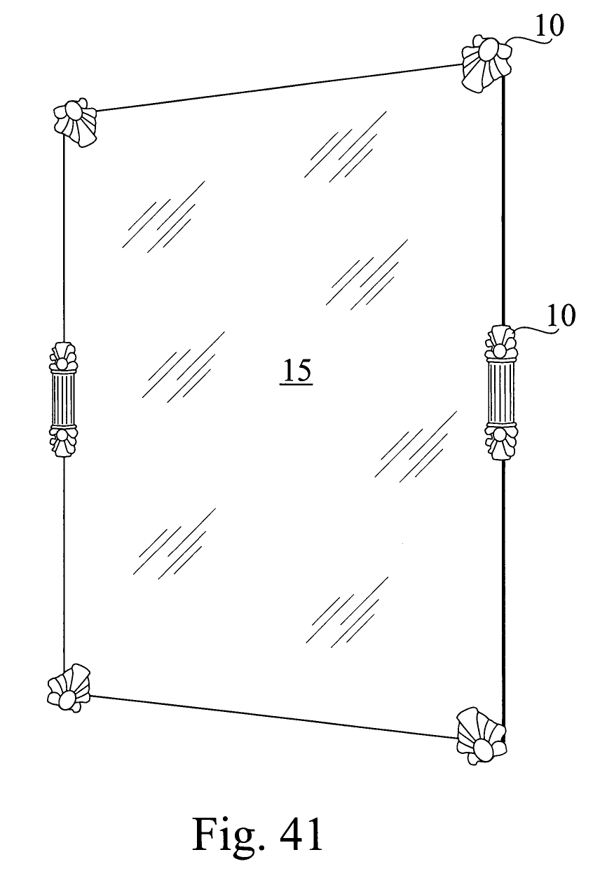

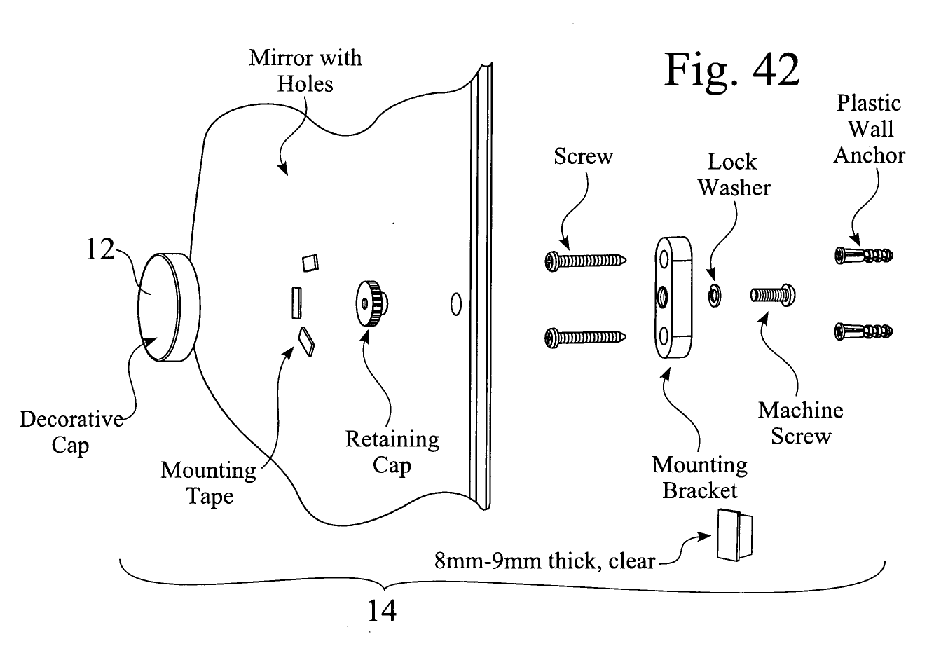

FIGS. 36, 37, 38, 39, 40, 41 and 42 depict decorative components 12, including buttons, strips, edge components and corners, that may be used in a variety of combinations, as well as hardware and connectors for an alternative attachment system.

In general, the various embodiments of the invention may be mounted or installed without special tools. The customer, purchaser or some other person who installs the decorations 10 may deploy the invention at home, in the office, or in some other suitable location without hiring a contractor.

III. Mirror Jewelry

One specific version of the invention comprises a collection of decorative mirror hardware (“Mirror Jewelry™”) that can be used to either decorate existing pre-hung frameless wall mirrors, or to mount mirrors and art to walls.

Currently, mirrors are hung with utilitarian looking plastic or metal clips. This hardware can replace or cover up these utilitarian clips allowing the consumer to dress up or decorate their mirrors.

The present invention would allow consumers to decorate their plain frameless mirrors without removing the mirror from the wall. When the invention is used on existing mirrors, a spacer would be attached to hold this decorative hardware away from the wall enough to clear the mirror and clips holding the frameless mirror in place. In this implementation, the hardware would not be used for support, but only as a decoration or to cover up blemishes in the mirror.

If the consumer were to mount a new mirror with this hardware, the decorative hardware would be attached to a flat surface such as a wall and the hardware would be used to support the mirror. The mirror would be trapped between the hardware and the wall.

This decorative hardware may be produced in a variety of shapes and sizes. The sizes and styles can range from a small button sized piece, to an ornate corner bracket to a decorative strip that would cover the whole edge of the mirror. The present invention may be made of many different materials such as wood, metal, plastic, glass, leather or fabric. The invention may be used on all shapes of mirrors such as rectangles, circles, ovals, octagons and free form shapes as well as mirrors with holes and cuts in them. A variety of mounting methods such as screws, clips, tape, glue, snaps, anchors or brackets may be used to mount these decorative pieces. The decorative pieces could also include functional elements such as hooks or magnifying mirrors.

The present invention may be mounted on existing mirrors which are already mounted in the home. These mirrors may be attached to the wall using a variety of kinds of hardware, including, but not limited to: metal spring clips, fixed metal clips and J-shaped molding which holds the mirror away from the wall. Mirror mastic and/or foam tape which adheres the back of the mirror to a wall. In another embodiment, plastic clips may be used to trap the mirror between the wall and clip.

When used with metal spring clips, fixed metal clips, J-shaped molding, mastic and/or foam tape, the decorations would be added to the mirror without removing the mirror or the mounting hardware. If plastic clips are used to mount the mirror to the wall, the decorative pieces may be used as a replacement for these clips. The decorations may also be used to mount a newly purchased mirror.

The present invention provides versatile mounting methods that may be employed to attach decorations to mirrors which have a variety of thicknesses and dimensions, or which are held away from a wall. In another alternative embodiment, the decorations may be attached to the surface of a mirror which does not provide an attachment space around its entire perimeter due to the position of adjoining walls or sink backsplashes.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Home Furnishing Enhancement System that have been disclosed above are intended to educate the reader about preferred embodiments of the invention, and are not intended to constrain the limits of the invention or the scope of Claims.

### LIST OF REFERENCE CHARACTERS

10 Home Furnishing Enhancement System
12 Ornamental component
14 Mounting component
15 Generally planar structure or mirror
16 Hole in mirror
18 Drywall or other generally vertical surface
19 Screw attached to ornamental component
20 Spacer
21 Notched side of spacer
22 Hole in spacer
23 Wall anchor
24 Mounting pegs on ornamental component
26 Drywall screw
28 Bracket for use with spacer stack
30 Spacer stack
32 Spring clips
34 Back side of mirror
36 Mounting holes for filigree piece
38 Screw
40 Bracket for mounting on drywall
42 Hole in bracket
44 Screws
46 Double-sided tape
48 Mirror clip
50 Screw for mirror clip
52 Spacer for use with mirror clip
54 Hole in mirror clip
56 Mirror mount
58 Spring clip
60 Recess
62 Alternative mirror mount
64 Threaded mounting hole
66 Notch
68 Threaded rod or press-fit pin
CW Cubicle wall
D Door
F Furnishing or generally planar structure
KC Kitchen cabinet
PF Picture frame
W Wall

What is claimed is:

1. A method comprising the steps of:
providing a set of enhancing components (10) for a generally planar structure (F); each of said set of enhancing components (10) including an ornamental component (12) and a mounting component (14); and
installing said set of enhancing components (10) around said generally planar structure (F); said installation being accomplished by a consumer.

2. A method as recited in claim 1, in which said generally planar structure (F) is a mirror (M).

3. A method as recited in claim 1, in which said generally planar structure (F) is a door (D).

4. A method as recited in claim 1, in which said generally planar structure (F) is a picture frame (PF).

5. A method as recited in claim 1, in which said generally planar structure (F) is a cubicle wall (CW).

6. A method as recited in claim 1, in which said ornamental component (12) is generally planar.

7. A method as recited in claim 1, in which said ornamental component (12) is manufactured from a lightweight material.

8. A method as recited in claim 1, in which said mounting component (12) is manufactured from a lightweight material.

9. A method as recited in claim 1, in which said set of enhancing components (10) comprises one component.

10. A method as recited in claim 1, in which said set of enhancing components (10) comprises a plurality of components.

11. A method as recited in claim 1, in which said set of enhancing components (10) is installed on an edge of said generally planar structure (F).

12. A method as recited in claim 1, in which said set of enhancing components (10) is installed around the perimeter of said generally planar structure (F).

13. A method as recited in claim 1, in which said set of enhancing components (10) is installed on a surface said generally planar structure (F).

14. A method as recited in claim 1, in which said mounting component (14) hangs on said generally planar structure (F).

15. A method as recited in claim 1, in which said mounting component (14) fits over said generally planar structure (F).

16. A method as recited in claim 1, in which said mounting component (14) adheres to said generally planar structure (F).

17. A method as recited in claim 1, in which said mounting component (14) is installed using a compression device.

18. A method as recited in claim 1, in which said mounting component (14) includes a threaded connector.

19. An apparatus comprising:
a set of enhancing components (10); said set of enhancing components (10) for deployment on a generally planar structure (F);
each of said set of enhancing components (10) including an ornamental component (12) and a mounting component (14);
each of said set of enhancing components (10) being installed by a consumer without the need for special tools or a contractor.

20. An apparatus as recited in claim 19, in which said generally planar structure (F) includes a hole (16).

21. An apparatus as recited in claim 20, in which said ornamental component (12) is mounted using said hole (16).

22. An apparatus as recited in claim 19, in which said generally planar structure (F) is a mirror (15).

23. An apparatus as recited in claim 19, further comprising a spacer (20) and a wall anchor (23).

24. An apparatus as recited in claim 23, in which said spacer (20) and said wall anchor (23) are used to mount said ornamental component (12) on said generally planar structure (F).

25. An apparatus as recited in claim 19, in which said ornamental component (12) is formed in a strip-like configuration.

26. An apparatus as recited in claim 25, in which said ornamental component (12) includes a peg (24) for mounting on said generally planar structure (F).

27. An apparatus as recited in claim 26, in which said generally planar structure (F) includes a hole (16), and in which said peg (24) is mounted in said hole (16).

28. An apparatus as recited in claim 19, further comprising a screw (26); said screw (26) for mounting said generally planar structure (F) in drywall (18).

29. An apparatus as recited in claim 19, in which said ornamental component (12) is mounted on a previously installed generally planar structure (F).

30. An apparatus as recited in claim 19, further comprising a spacer (20) for placement generally in between said ornamental component (12) and said generally planar structure (F).

31. An apparatus as recited in claim 30, in which said spacer (20) includes
a notch (21) for receiving and holding said generally planar structure (F); and
a hole (22) for mounting said ornamental component (12).

32. An apparatus as recited in claim 22, further comprising a bracket (28), a spacer (30) and a screw (26); said ornamental component (12) being attached to said mirror (15) using said bracket (28), said spacer (30) and said screw (26).

33. An apparatus as recited in claim 19, in which said ornamental component (12) includes a spring clip (32) which is used to fit over a corner of said generally planar structure (F).

34. An apparatus as recited in claim 19, in which said ornamental component (12) includes a spring clip (32) which is used to fit over an edge of said generally planar structure (F).

35. An apparatus as recited in claim 19, in which said ornamental component (12) includes a spring clip (32) which is used to install said ornamental component (12) around the perimeter of said generally planar structure (F).

36. An apparatus as recited in claim 19, in which said ornamental component (12) is affixed to said generally planar structure (F) using double-sided tape (46).

37. An apparatus as recited in claim 19, in which said ornamental component (12) is affixed to said generally planar structure (F) using an adhesive.

38. An apparatus as recited in claim 19, further comprising:
a first bracket (40);
a screw (39); said screw (39) being attached to said ornamental component (12);
said first bracket (40) for attachment to the back side (34) of said mirror (15) using said screw (39);
a drywall screw (44); and
a second bracket (42);
said second bracket (42) for attachment to drywall (18) using said drywall screw (44).

39. An apparatus as recited in claim 22, further comprising a mirror clip (48) and a mirror clip screw (50) for attaching said ornamental component (12) to said mirror (15).

40. An apparatus as recited in claim 22, further comprising a mirror clip (48) and a mirror clip screw (50) for attaching said ornamental component (12) to said mirror (15).

41. An apparatus as recited in claim 22, further comprising a mirror mount (62); said mirror mount including
a threaded mounting hole (64) formed in said ornamental component (12),
a notch (66) to receive said mirror (15), and
a threaded rod (68) for engaging said threaded mounting hole (64) formed in the decorative component (12).

42. An apparatus as recited in claim 19, further comprising a mirror mount (62); said mirror mount including
a threaded mounting hole (64) formed in said ornamental component (12);
a notch (66) to receive said mirror (15), and
a press-fit pin for engaging said threaded mounting hole (64) formed in said ornamental component (12).
